(19) United States
(12) Patent Application Publication
(10) Pub. No.: US 2026/0338493 A1
(43) Pub. Date: Oct. 29, 2026

(54) STORAGE DEVICE

(71) Applicant: Stühff Maschinen- und Anlagenbau GmbH, Geesthacht (DE)

(72) Inventors: Holger Hans STÜHFF, Geesthacht (DE); Thorbjørn STÜHFF, Geesthacht (DE)

(21) Appl. No.: 19/124,378

(22) PCT Filed: Oct. 18, 2023
(86) PCT No.: PCT/EP2023/078994

§ 371 Date: Apr. 25, 2025

(30) Foreign Application Priority Data
Nov. 2, 2022 (EP) 22205137.7

(51) Int. Cl. F28D 20/02; F28D 1/06; F28D 9/00; F28D 20/00

(52) U.S. Cl. CPC F28D 20/021; F28D 1/06; F28D 9/0037; F28D 2020/0013

(57) ABSTRACT

A storage device includes several storage modules (2) which are stacked onto one another. The storage modules (2) each have at least one storage container (10) and each have at least one heat transfer medium channel (22) which is adjacent to an outer wall of the storage container (10). The heat transfer medium channels (22) of the several storage modules (2) are connected to one another via at least one heat transfer medium connection conduit.

### CROSS REFERENCE TO RELATED APPLICATIONS

This application is a United States National Phase Application of International Application PCT/EP2023/078994, filed Oct. 18, 2023, and claims the benefit of priority under 35 U.S.C. § 119 of European Application 22205137.7, filed Nov. 2, 2022, the entire contents of which are incorporated herein by reference.

### TECHNICAL FIELD

The invention relates to a storage device which is designed for storing energy in the form of heat and/or hydrogen.

### BACKGROUND

It is known to store thermal energy in a heat store, such as e.g. a latent heat store. Moreover, it is possible to store hydrogen in metal hydride stores. In the case of heat stores, storage containers are provided and these are filled e.g. with a latent heat storage material which can be heated via a heat transfer medium and conversely can deliver the heat again to the heat transfer medium. Metal hydride hydrogen stores comprise a metal hydride in a storage container, in which metal hydride hydrogen is bonded. On bonding hydrogen, heat is released, whereas heat must be fed for releasing the hydrogen. A suitable heat transfer medium can be used for this.

### SUMMARY

It is the object of the invention to provide a modular storage device which is inexpensive to manufacture and can be easily adapted in its size and its storage volume.

This object is achieved by a storage device with features according to the invention. Preferred embodiments result from this disclosure, including the subsequent description and claims as well as the attached figures.

The storage device according to the invention in particular is configured for storing energy in the form of heat and/or in the form of hydrogen. The storage device according to the invention is constructed in a modular manner, i.e. is composed of several storage modules. The storage modules are stacked onto one another so that they are arranged lying on one another or standing next to one another. Herein, the storage modules are designed essentially independently of one another, i.e. in particular each have a closed storage volume. Preferably, in the state in which they are stacked onto one another, the storage modules are also separated from one another in a manner such that no fluid connections whatsoever are provided between individual storage modules in the region of their contact surfaces. This simplifies the assembly since no seals are necessary between the storage modules. The modular construction in particular has the advantage that the number of storage modules in a storage device can be easily varied so that inexpensive storage devices of different sizes can be constructed from standardised modules.

The storage modules each comprise at least one storage container. Herein, the storage container is an essentially closed container whose necessary walls are part of the associated storage module. I.e. each storage container is completely part of an individual storage module and forms a closed off volume in the individual storage module. The storage modules further each comprise at least one heat transfer medium channel which is adjacent to an outer wall of the storage container. Thus a heat transfer medium, in particular a fluid heat transfer medium which flows through the heat transfer medium channel can temperature control the storage container, i.e. heat it or cool it, depending on the application. The heat transfer medium channel is herein preferably arranged such that a good heat transition between a heat transfer medium in the inside of the heat transfer medium channel and the outer wall of the storage container is realised. Preferably, the heat transfer medium flows directly over the outer wall of the storage container, or the heat transfer medium channel s connected to the outer wall of the storage container in a thermally conductive and suitable manner. The heat transfer medium channels of the several storage modules are connected to one another. For this, at least one heat transfer medium connection conduit is provided and this is in connection with the heat transfer medium channels of the individual storage modules, which is to say connected onto these in a fluid-leading manner. The heat transfer medium connection conduit is herein designed separately from the storage modules, so that these do not need to be directly connected amongst one another in a fluid-leading manner, but the heat transfer medium channels of the individual storage modules via the at least one separate heat transfer medium are connected to one another connection conduit and furthermore to a heat source and/or cooling device. Valves can be arranged in the at least one heat transfer medium connection conduit and/or in their connection to the heat transfer medium channels, said valves permitting a heat transfer medium flow to be set or regulated.

The at least one heat transfer medium connection conduit is preferably designed as a piping which is external of the storage modules. The heat transfer medium connection conduit is herein preferably designed such that it is connected to the storage modules after these are stacked onto one another and fixed onto one another. For this, the storage modules can comprise suitable connections, for example connection pipe stubs, onto which such an external piping can be connected. The heat transfer medium connection conduit connects the heat transfer medium channels of the storage modules to one another and to external components. The storage modules can be designed such that their heat transfer medium channels each comprise two connections, preferably an inlet and an outlet, wherein then for example the inlets can be connected to a heat transfer medium inlet conduit and the outlets to a heat transfer medium outlet conduit. In this manner, the heat transfer medium channels of the individual storage modules are connected in parallel. However, other connections or circuits are also possible, so that the heat transfer medium channels can be subjected to throughflow for example in alternating flow directions which are opposite to one another or by an in total meandering flow direction.

The storage containers of the storage modules each have an outer wall which according to a possible embodiment comprises a first wall surface and a distanced second wall surface which extends in parallel. In the edge region, this first and second wall surface can be connected to one another in a sealed manner via a peripheral wall. The first and the second wall surface and the mentioned peripheral wall then define the volume of the storage container. The at least one heat transfer medium channel is preferably adjacent to the first and/or to the second wall surface. A good thermal transition onto the adjacent wall surface from the heat transfer medium channel or a heat transfer medium which flows in this is realised. Heat can be brought into the inside of the storage container or be led away out of the inside of the storage container, via the wall surface.

According to a further preferred embodiment, the storage containers each comprise a first heat transfer medium channel which is adjacent to the first wall surface and a second heat transfer medium channel which is adjacent to the second wall surface. In this manner, the storage container is temperature-controlled at two opposite sides by the heat transfer medium which flows through the heat transfer medium channels. Thus, a large-surfaced and uniform temperature control can be achieved.

According to a further embodiment of the invention, the at least one heat transfer medium channel extends extensively along at least one wall surface of the outer wall of the associated storage container. Thus, a heat transfer medium in the heat transfer medium channel can flow over a larger surface of the storage container. Preferably, such heat transfer medium channels are arranged on two wall surfaces, i.e. a first and a second wall surface as has been described above.

The heat transfer medium channels can each be delimited in a direct manner by a wall surface of the outer wall of the associated storage container. Preferably, a channel wall which is connected to the wall surface is provided and this is distanced to the wall surface at least in part-regions, so that a free space which forms the heat transfer medium channel is formed between the wall surface of the storage container and the channel wall. The channel wall further preferably extends parallel to the wall surface of the outer wall of the storage container at least in part-regions, so that preferably an extensive heat transfer medium channel is formed between the channel wall and the wall surface. The channel wall is preferably connected to the wall surface in the peripheral region of this channel wall. Moreover, connections or connection webs can also be provided in the inner region. Such connections can be created for example by way of a suitable shaping of the channel wall, for example these can comprise indentations which are directed towards the wall surface and further preferably are connected to this.

The channel wall can be formed for example by a sheet element which is sealingly connected to the wall surface which further preferably is likewise formed from sheet. Preferably, the channel wall can be welded to the wall surface.

Aluminium or aluminium alloys but also steel, particularly preferably stainless steel and/or austenitic steel are considered as materials for the channel wall as well as the outer wall of the storage container.

The storage containers of the storage modules are preferably of sheet, in particular of sheet metal. Here too, preferably the aforementioned materials are applied. Preferably, at least one wall surface of the outer wall and preferably the wall surfaces to which the heat transfer medium channels are adjacent are sheet parts. These can be inexpensively cut into the desired shape and possibly be brought into the desired shape by reshaping. Sheet metal parts furthermore permit a good heat transfer from the heat transfer medium channels into the inside of the storage container. The wall surfaces which are formed of sheet metal are preferably connected in a distanced manner to one another via a peripheral wall. Such a peripheral wall can likewise be formed of one or more sheet metal parts and be welded e.g. to the mentioned wall parts. The peripheral wall could also be formed as one piece with the wall surfaces or at least one of the wall surfaces of the outer wall. The necessary three dimensional design for forming a cavity in the inside of the storage container could be achieved for example by way of reshaping the sheet parts.

The individual storage modules are preferably stacked onto one another between two bearing elements so that they are pressed on one another or held on one another by the two bearing elements. Herein, the individual storage modules are preferably parallel to one another in a manner such that the described wall surfaces extend parallel to one another with the heat transfer medium channels of the individual storage modules. The bearing elements can be designed as bearing plates. The two bearing elements are arranged at the opposite ends of the module stack and are connected to one another via clamping elements. Herein, the clamping elements preferably extend laterally of the storage modules. The clamping elements can be designed for example as bolts or threaded rods, wherein the necessary pressure between the bearing elements and onto the storage modules which lie therebetween can be exerted by screwing. The clamping elements as bolts can extend for example through the bearing elements and be fixed at the sides which are away from the storage modules by way of nuts or screws. If the clamping elements are designed as rods or threaded rods, they can also be provided in the necessary length which is adapted to a number of storage modules which are to be stacked on one another. This favours the modular construction, concerning which different numbers of storage modules are stacked onto one another according to requirements. The rods or threaded rods as standard parts can be easily cut to size to the desired measure.

The individual storage modules preferably comprise carrier structures which in particular carry or support the storage containers. The carrier structures for example stand on at least one rest surface so that each storage module is directly supported on a rest surface. The carrier structure can be designed for example as a frame which surrounds the storage container and which is connected to an outer wall of the storage container in a force-transmitting manner, e.g. welded.

If the storage device is applied as a heat storage device storage device, then a heat storage material, in particular a latent heat storage material is arranged in the inside of the at least one storage container of at least one storage module. This for example can be wax or paraffin. However, depending on the desired temperature level, any other suitable latent heat storage material can also be arranged in the inside of the storage container. The storage container is closed after the latent heat storage material has been brought into this. A filling opening which is closed after the filling can be provided for introducing in the material. This can be effected for example by a plug and be designed as a permanent or releasable closure. Alternatively, the material can be incorporated before the storage container is permanently closed for example by a welding of a wall element such as e.g. one of the wall surfaces or a part of the peripheral wall. The latent heat storage material is therefore preferably arranged in a closed-off volume which is defined by the storage container. The heat exchange is then effected solely by a heat transfer medium which flows through the heat transfer medium channel or the heat transfer medium channels. In this application case, no connection is necessary between the storage containers or the interiors of the storage containers. The storage device can comprise a multitude of such storage modules which are designed as a heat store.

If the storage device is applied as a hydrogen store, a metal hydride is arranged in the inside of the at least one storage container of at least one storage module, said metal hydride being designed or suitable for storing hydrogen. For this, basically any suitable metal hydride can be applied. Concerning this application case, the storage containers comprise suitable connections or connection openings in order to bring hydrogen into the inside of the storage containers and to remove it from these again. The fed hydrogen is bonded by the metal hydride in the storage containers, wherein a part of the hydrogen remains gaseous in the inside of the storage container. The storage device can comprise a multitude of such storage modules which are designed as hydrogen stores. Preferably, the storage containers each comprise at least one conduit connection and the conduit connections of the individual storage containers of several storage modules are preferably connected to one another via at least one storage connection conduit. Herein, the storage connection conduit is preferably likewise a separate conduit connection which is effected outside the storage modules. I.e. the storage modules are not directly connected to one another on stacking the storage modules onto one another or on arranging them, so that no sealing is necessary between the individual storage modules. This simplifies the assembly.

It is possible to design the storage device according to the invention with several storage modules exclusively as a heat store or exclusively as a hydrogen store. If the storage device is designed exclusively as a heat store, then preferably the storage containers of all storage modules are filled with a heat storage material. If the storage device is designed exclusively as a hydrogen store, then preferably the storage containers of all storage modules are filled with a metal hydride. Furthermore, in a special embodiment, a combination of a hydrogen store and heat store in a single storage device is possible. For this, in a storage device at least one storage module can be designed as a heat store and at least one storage module as a hydrogen store. Given a multitude of storage modules, thus a part of the storage modules can be designed as heat stores and another part as hydrogen stores. The different modules can be arranged for example in an alternating manner or however in blocks of storage modules of the same type. The combination of heat storage modules and hydrogen storage modules in a storage device has the advantage that the heat which is released by the metal hydride on filling can be stored in the heat storage modules within the storage device and later can be fed again to the hydrogen storage modules in order to drive the hydrogen out of the metal hydride. The heat transfer is herein effected via a heat transfer medium which flows through the heat transfer medium channels and at least one heat transfer medium connection conduit.

The at least one storage connection conduit is preferably designed as piping which is external of the storage modules and which connects the storage containers of the storage modules. This piping preferably extends laterally along the storage modules. The piping is expediently attached after the assembly of the storage modules into a module stack, i.e. after the stacking upon one another

According to a further preferred embodiment, the storage containers each comprise at least two conduit connections, e.g. an inlet connection and an outlet connection which are preferably arranged at sides of the storage container which are opposite or away from one another. In such a case at least two storage connection conduits can be provided, e.g. an inlet conduit which connects the inlet connections with one another and an outlet conduit which connects the outlet connections to one another.

The metal hydride is preferably arranged in the form of blocks with spacer elements which are arranged between these in the at least one storage container, but can also be brought in as a granulate or powder. These blocks are arranged in the storage container before this is closed, for example before placing on the last side wall or wall surface which is then welded to the peripheral wall. The spacer elements serve for placing the metal hydride blocks in the inside of the storage container in a defined manner before the storage container is subjected to or filled with hydrogen for the first time. The metal hydride expands with the first storage of hydrogen. In order to ensure a uniform expansion, distances which are ensured by the spacer elements are provided on assembly. The spacer elements and the blocks are preferably designed and dimensioned such that the metal hydride completely fills out the storage container after the first receiving of hydrogen, i.e. in particular come to bear on the inner sides of the described wall surfaces of the storage container, so that an optimal heat transition via the wall surfaces into the inside of the metal hydride is ensured. Simultaneously however, a further expansion which would lead to a deformation of the storage containers should preferably be avoided, so that for example the heat transfer medium channels are also not deformed or damaged.

Intermediate plates can be arranged in the module stack between the neighbouring storage modules which is to say the storage modules which are adjacent one another. These plates can ensure a uniform force transmission between the individual storage modules and a play-free bearing contact of the storage modules and/or a thermal decoupling between the storage modules. The intermediate plates can be designed from a heat-insulating material and/or an elastic material, which can accommodate deformations, for example due to thermal expansion. For the thermal decoupling or heat insulation between adjacent storage modules, the intermediate plates are preferably manufactured of a material with suitable insulation properties or with a poor thermal conductivity, e.g. of plastic.

According to a further preferred embodiment, the complete storage device can be encased. An encasing which surrounds the storage device with its storage modules particularly preferably can comprise a thermal insulation or be formed by a thermal insulation. Any insulating material which is suitable for the application purpose, for example rock wool or mineral wool or a foamed plastic material can be used as a thermal insulation. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a perspective view of a storage device according to the invention;

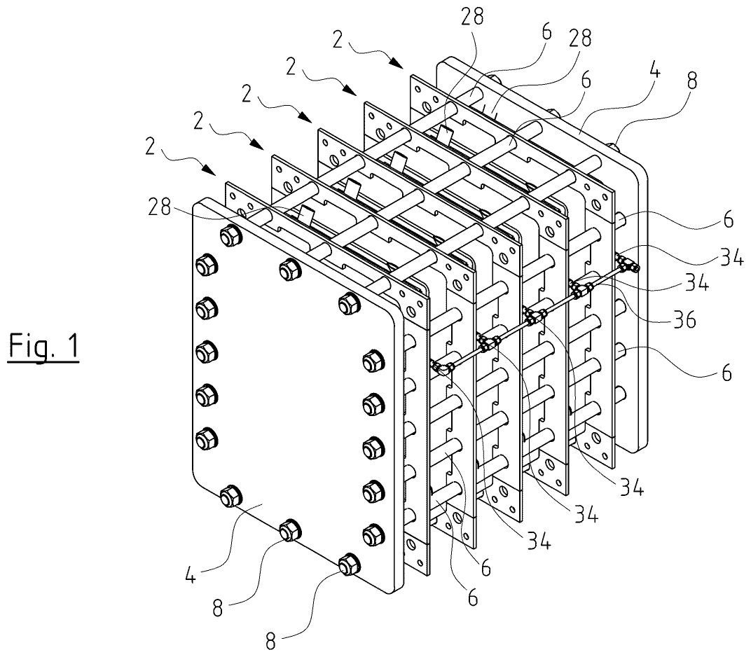

FIG. 2 is a lateral view of the storage device according to FIG. 1;

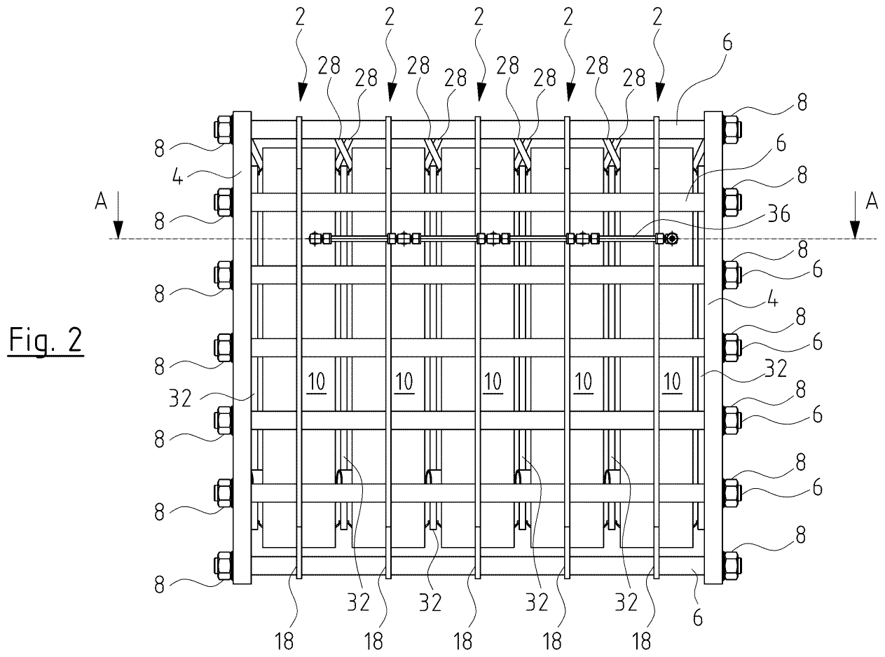

FIG. 3 is a sectioned view along the line A-A in FIG. 2;

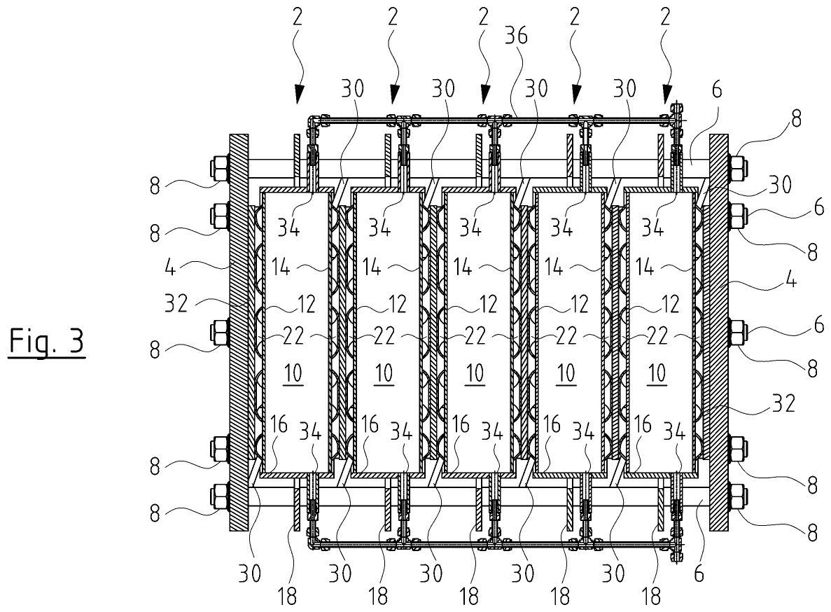

FIG. 4 is a plan view of a storage module of the storage device; and

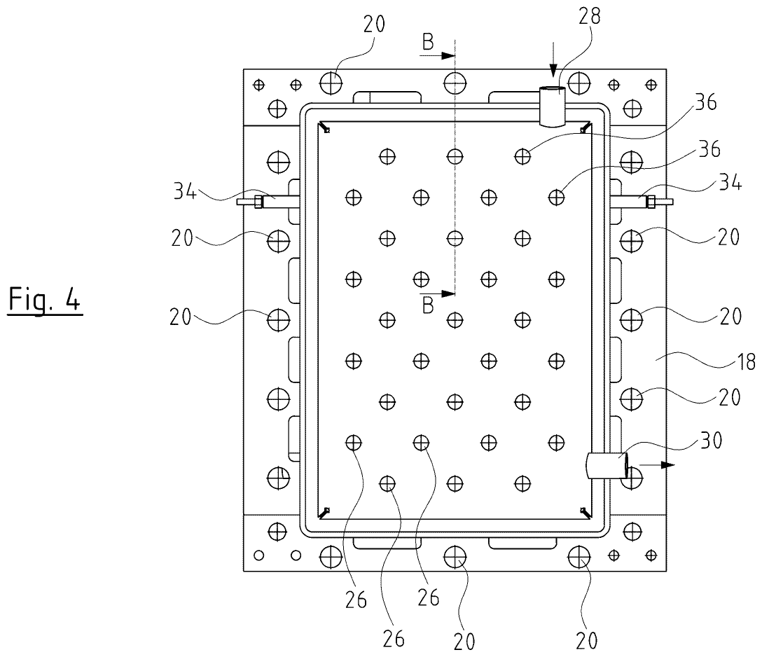

FIG. 5 is a sectioned view along the line B-B in FIG. 4.

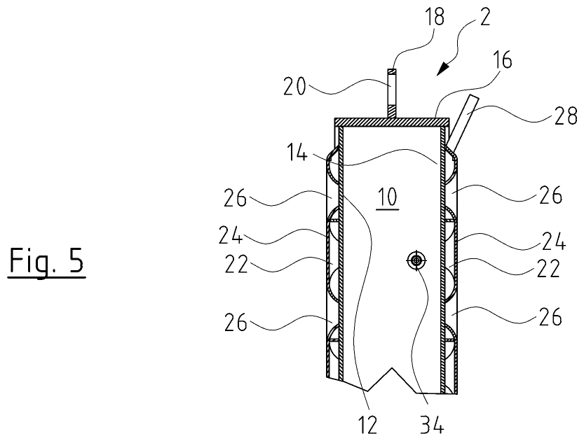

### DESCRIPTION OF PREFERRED EMBODIMENTS

Referring to the drawings, the storage device according to the invention is designed as a hydrogen store and in this case comprises five storage modules 2. The storage modules 2 are stacked onto one another parallel to one another and lie between two bearing plates 4 which are connected to one another via rods or bolts 6. The rods 6 form clamping elements and extend through the bearing plates 4. The rods 6 are screwed by nuts 8 at the sides of the bearing plates 4 which are away from the storage modules 2. Thus a pressing force between the plates 4 is exerted via the nuts 8 and the rods 6 and these plates maintain the bearing contact of the storage modules 2 and counteract the pressure forces which occur in the storage modules 2.

The storage modules 2 are designed identically and each comprise a storage container 10 which in the case of a hydrogen store is filled with a metal hydride which is not shown here in the figures. The storage containers 10 comprise an outer wall which is formed by two parallel wall surfaces 12 and 14 which are distanced to one another. The wall surfaces 12 and 14 are designed as sheet parts and are connected to one another in their peripheral region by way of a peripheral wall 16. The peripheral wall 16 can be designed as a bent sheet strip which is shaped and welded into a closed ring. Alternatively, it can be designed by several welded sheet elements. The wall surfaces 12 and 14 are likewise welded to the peripheral wall 16. The thus formed storage containers 10 are inserted into a surrounding frame 18 which can likewise be manufactured from a sheet component. The frame 18 thus projects transversely of the peripheral wall. The frame 18 comprises through-holes 20, through which the rods 6 extend. The frames 18 are therefore guided on the rods 6 or positioned to the rods in the transverse direction. This permits the threading of the storage modules 2 onto the rods 6 so that they are positioned between the bearing plates 4 in a defined manner. The frames 18 are each welded to the adjacent peripheral wall 16, but could also be connected to the peripheral wall 16 in a force-transmitting manner in another way, e.g. by way of screwing or riveting. The frames 18 preferably serve as carrier structures for the storage modules 2 by way of the individual frames standing on a placement surface or bearing element and thus transmitting the weight force of the associated storage module 2 directly onto the placement surface or the bearing element.

Heat transfer medium channels 22 are formed in each of the storage modules 2 at the outer sides of the wall surfaces 12 and 14, i.e. the sides which are away from the interior of the storage container 10. The heat transfer medium channels 22 are defined between the wall surfaces 12 and 14 and a channel wall 24 which attaches from the outside. The channel walls 24 are designed as sheet shape parts and are shaped such that in their main extension they extend essentially parallel to the wall surfaces 12 and 14. They are shaped such that they are distanced in individual regions, i.e. are distanced to the wall surfaces 12 and 14 in the larger part of their extension, so that free spaces are formed, such defining extensive heat transfer medium channels 22. At the outer periphery, the channel walls 24 are shaped such that they come into contact with the wall surfaces 12 and 14 and are sealingly welded there. In the middle region, the channel walls 24 face inwards, i.e. comprise indentations 26 which are directed towards the wall surfaces 12 and 14 and whose bases are designed as holes, wherein the peripheral walls of the indentations 26 come into contact with the adjacent wall surface 12, 14 and are likewise sealingly welded. The heat transfer medium channels 22 each have an inlet 28 and an outlet 30 which are arranged at opposite sides of the heat transfer medium channels 22. The inlets 28 can be connected to an inlet conduit and the outlets 30 to an outlet conduit, for the feed and discharge of a fluid heat transfer medium. The heat transfer medium can then flow through the heat transfer medium channels 22 in order to regulate the temperature of the storage containers 10, in particular to cool them on receiving hydrogen and heat them for driving out the hydrogen. Herein, what is essential is that the respective connection conduits and connections of the heat transfer medium channels 22 of the individual storage modules 2 is effected outside these storage modules 2 by an external piping, i.e. the heat transfer medium channels 22 of the individual storage modules 2 are not directly connected to one another on arranging the modules.

In this embodiment, the channel walls 24 of adjacent storage modules 24 do not come into direct bearing contact with one another on arranging the storage modules 2, but intermediate spaces 32 are arranged between the individual storage modules 2 and also between the storage modules 2 the bearing plates 4. These serve for the thermal decoupling of the adjacent storage modules 2 and for this are manufactured of a poor thermally conductive material such as e.g. plastic. Preferably, the material of the intermediate plates 32 can additionally have elastic characteristics and thus permits a uniform force transmission and can for example compensate thermal expansions.

The storage containers 10 further comprise at least one conduit connection 34. In this embodiment example, each of the storage modules comprises two conduit connections 34 which are formed at opposite sides of the peripheral wall 16. The conduit connections 34 serve for leading hydrogen into and out of the storage container 10. The individual conduit connections 34 are each connected to a storage connection conduit 36 outside the storage modules 2, i.e. outside the storage containers 10. I.e. here too, an external piping is provided and this does not create the connection between the storage containers 10 until after the stacking or arranging of the modules. I.e. there is no direct connection between the storage containers 10.

The described modular storage device instead of being used as a hydrogen store can also be used as a heat store in a slight modification, in particular as a latent heat store. In such a case, the conduit connections 34 would serve for filling the storage containers 10 with a heat storage material, in particular a latent heat storage material, for example wax or the like. Subsequently, the conduit connections 34 are closed, for example by way of plugs. These closures can be designed in a permanent or also releasable manner. They could also be effected via the storage connection conduits 36 which are subsequently closed or removed. Alternatively, one could make do without the storage connection conduits 36 for the application as a heat store and the storage containers 10 for example could be filled individually. The heat feed and discharge to and from the heat store is effected by a fluid heat transfer medium which is led through the heat transfer medium channels 22.

In a preferred embodiment of the storage device, the hydrogen store and the heat store can be combined so that the heat store stores the heat which arises on receiving the hydrogen in the metal hydride and provides it again later for driving out the hydrogen. This can be effected in a manner such that at least one storage device which is designed as a hydrogen store is operated in combination with at least one storage device which is designed as a heat store. In a particular embodiment however it is also possible within the storage device to form a part of the storage modules 2 as a hydrogen store and another part of the storage modules 2 as a heat store. Herein, the different storage modules 2 can be arranged in an alternating manner or also be arranged combined into blocks of the same type of storage modules 2.

While specific embodiments of the invention have been shown and described in detail to illustrate the application of the principles of the invention, it will be understood that the invention may be embodied otherwise without departing from such principles.

### LIST OF REFERENCE NUMERALS

2 storage modules
4 bearing plate
6 rods
8 nuts
10 storage container
12, 14 wall surface
16 peripheral wall
18 frame
20 through-holes
22 heat transfer medium channels
24 channel wall
26 indentations
28 inlet
30 outlet
32 intermediate plates
34 conduit connections
36 storage connection conduit

1. A storage device comprising several storage modules which are stacked onto one another, characterised in that wherein the storage modules each comprise:
at least one storage container; and
at least one heat transfer medium channel which is adjacent to an outer wall of the storage container and the heat transfer medium channels of the several storage modules are connected to one another via at least one heat transfer medium connection conduit.

2. The storage device according to claim 1, wherein the at least one heat transfer medium connection conduit is configured as a piping which is external of the storage modules and which connects the heat transfer medium channels of the storage modules.

3. The storage device according to claim 1, wherein the outer wall of the storage containers each comprises a first wall surface and a distanced second wall surface which extends in parallel, wherein the at least one heat transfer medium channel is adjacent to the first and/or the second wall surface.

4. The storage device according to claim 3, wherein the storage containers each comprise a first heat transfer medium channel which is adjacent to the first wall surface and a second heat transfer medium channel which is adjacent to the second wall surface.

5. The storage device according to claim 1, wherein the at least one heat transfer medium channel extends extensively along at least one wall surface of the outer wall of the associated storage container.

6. The storage device according to claim 1, wherein the at least one heat transfer medium channel is delimited by a wall surface of the outer wall of an associated storage container and by a channel wall which is connected to the wall surface.

7. The storage device according to claim 6, wherein the channel wall is formed by a sheet element which is sealingly connected; to the wall surface.

8. The storage device according to claim 1, wherein at least one wall surface of the outer wall comprises one or more sheet parts.

9. The storage device according to claim 1, wherein the storage modules are stacked onto one another, are arranged between two bearing elements, and are connected to one another via clamping elements.

10. The storage device according to claim 1, wherein a heat storage material is arranged in the inside of the at least one storage container of at least one storage module.

11. The storage device according to claim 1, wherein a metal hydride, which is configured for storing hydrogen, is arranged in the inside of the at least one storage container of at least one storage module.

12. The storage device according to claim 1, wherein the storage containers each comprise at least one conduit connection.

13. The storage device according to claim 12, wherein the at least one storage connection conduit is configured as a piping which is external of the storage modules and which connects the storage containers of the storage modules.

14. The storage device according to claim 11, wherein the metal hydride is arranged in the form of blocks with spacer elements which are arranged between the blocks in the at least one storage container.

15. The storage device according to claim 1, wherein an intermediate plate is arranged between adjacent storage modules.

16. The storage device according to claim 6, wherein the sheet element is welded to the wall surface.

17. The storage device according to claim 3, wherein the at least the wall surface to which the heat transfer medium channels are adjacent, comprise one or more sheet parts.

18. The storage device according to claim 9, wherein the clamping elements extend laterally relative to the storage modules.

19. The storage device according to claim 12, wherein the conduit connections of the storage containers of the several storage modules are connected to one another via at least one storage connection conduit.

20. The storage device according to claim 14, wherein the spacer elements and the blocks are configured and dimensioned such that the metal hydride completely fills out the storage container after first receiving hydrogen.
